(19) United States
(12) Patent Application Publication
(10) Pub. No.: US 2015/0149621 A1
(43) Pub. Date: May 28, 2015

(54) METHOD AND SURVEY SERVER FOR GENERATING PERFORMANCE METRICS OF URLS OF A WEBSITE

(71) Applicant: IPERCEPTIONS INC., Montreal (CA)

(72) Inventors: Matthew BUTLER, Montreal (CA); Lane COCHRANE, Kirkland (CA); Audry LAROCQUE, Ville Mont-Royal (CA)

(21) Appl. No.: 14/538,186

(22) Filed: Nov. 11, 2014

Related U.S. Application Data
(60) Provisional application No. 61/908,995, filed on Nov. 26, 2013.

(51) Int. Cl. H04L 12/26; G06F 17/30; H04L 29/08

(52) U.S. Cl. CPC H04L 43/04; H04L 67/10; H04L 67/22; G06F 17/30887
USPC 709/224

(57) ABSTRACT

A method and survey server for generating performance metrics of URLs of a website. The survey server collects website visit data from a plurality of user devices. The website visit data comprise URLs of webpages of the website displayed on each specific user device during a visiting of the website by a user of the specific user device. The survey server also collects participation data from some of the plurality of user devices. The survey participation data correspond to survey information received from the users of the user devices in relation to the visit of the website, and comprise an indication of the users having either or not fulfilled a purpose of visit. The survey server further analyzes the website visit data and the survey participation data to generate performance metrics of the URLs of the website with respect to fulfilling the purpose of visit of the website.

### TECHNICAL FIELD

The present disclosure relates to the field of website evaluation, and more precisely to a method and survey server for generating performance metrics of URLs of a website.

### BACKGROUND

Nowadays, it is very important for corporations to understand the potential intent of website visitors in relation with their brand, services and products. Inaccurate identification of website visitors' intents may result in great losses, for instance loss of sales, inaccurate responses to the needs, loss of fidelity to the brand, etc. Accordingly, any tool to increase the corporate understanding of website visitors, and the validity level associable to this knowledge, has important value for corporations.

The same applies to tools used to interact with website visitors. The more efficient they are, the more efficient the processes to monetize the interactions with these website visitors. Accordingly, evaluation tools are necessary to establish the efficiency of the tools used to interact with the website visitors, including tools used to evaluate websites.

Currently the most commonly used tools to acquire this kind of information (i.e. understanding the level of success of a website) consist in the following types of tools: (1) web analytics tools such as Google Analytics and (2) survey tools. Another type of available tool consists in: (3) session recording tools, also known as session replay processes. While the first type provides tools to follow actions performed by website visitors (therefore respond to the WHAT question), it fails to provide tools to understand the reasons for a website visitor not completing a task (the WHY question), such as not being able to complete a purchase. The second type, while being effective to understand the reasons for a website visitor for not having completed a task, lacks to provide perspective on the bases for the opinions provided by the website visitor in his answers to a survey (e.g. fails to provide any hint of a solution to correct the situation). The third type, as good as it is to understand the actions of a website visitor, remains (as the first type of tools) based on actions performed by website visitors.

None of these types of tools taken alone provides a way to obtain a good understanding of what the website visitors like or dislike from the website, what in their visiting has driven them to complete a task or to leave the website before completing the task they initiated, and what event or element encountered during their website visit has driven them to express dissatisfaction. Accordingly, none of these types of tools taken alone enables a corporation to improve the structure of its website, identifying the webpages that may lead the website visitors to either succeed or fail in regard to the objectives they had for visiting the website.

There is therefore a need for method and survey server for generating performance metrics of URLs of a website.

### SUMMARY

According to a first aspect, the present disclosure provides a method for generating performance metrics of URLs of a website. The method comprises collecting at a survey server website visit data from a plurality of user devices. The website visit data comprise, for each specific user device, Uniform Resource Locators (URLs) of webpages of the website displayed on a display of the specific user device during a visiting of the website by a user of the specific user device. The method comprises collecting at the survey server survey participation data from some of the plurality of user devices. The survey participation data correspond to survey information received from the users of the user devices in relation to the visit of the website. The survey participation data comprise an indication of the users having either or not fulfilled a purpose of visit during the visit of the website. The method further comprises analyzing by the survey server the website visit data and the survey participation data to generate performance metrics of the URLs of the website with respect to fulfilling the purpose of visit of the website.

According to a second aspect, the present disclosure provides a computer program product comprising a readable memory storing computer executable instructions thereon. The instructions, when executed by a processing unit of a survey server, provide for generating performance metrics of URLs of a website according to the aforementioned method.

According to a third aspect, the present disclosure provides a survey server. The survey server comprises a processing unit, a communications interface for exchanging data with a plurality of user devices, and a memory for storing web site visit data and survey participation data. The memory further stores code responsible, when performed by the processing unit, for collecting the website visit data from the plurality of user devices. The website visit data comprise, for each specific user device, Uniform Resource Locators (URLs) of webpages of the website displayed on a display of the specific user device during a visit of the website by a user of the specific user device. The code is also responsible for collecting the survey participation data from some of the plurality of user devices. The survey participation data correspond to survey information received from the users of the user devices in relation to the visit of the website. The survey participation data comprise an indication of the users having either or not fulfilled a purpose during the visit of the website. The code is further responsible for analyzing the website visit data and the survey participation data to generate performance metrics of the URLs of the website with respect to fulfilling the purpose of visit of the website.

### BRIEF DESCRIPTION OF THE DRAWINGS

Embodiments of the disclosure will be described by way of example only with reference to the accompanying drawings, in which:

FIG. 1 is an exemplary schematic illustration of a survey server in communication over the Internet;

FIG. 2a is an exemplary schematic illustration of a user device of FIG. 1 hosting a web client

FIG. 2b is an exemplary schematic functional illustration of the web client of FIG. 2a;

FIG. 2c is an exemplary schematic functional illustration of additional components of the web client of FIG. 2a;

FIGS. 3a and 3b are exemplary schematic illustrations of interactions between the user device, the web server and the survey server of FIG. 1;

FIG. 4 is an exemplary flow chart illustrating steps performed by the user device of FIGS. 1 and 2a;

FIG. 5 is an exemplary flow chart illustrating steps performed by the survey server of FIG. 1;

FIG. 6 is a simplified exemplary schematic illustration of the survey server of FIG. 1; and

FIGS. 7a, 7b and 7c are representations of reports generated by the survey server of FIG. 6.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to the evaluation of the performance of a website with respect to satisfying its visitors, in particular with respect to satisfying a purpose of visit of the visitors of the website. The following terminology is used throughout the present disclosure:
Web survey: A web survey aims at collecting user feedback related to the browsing of a website by a user. The term survey is used in a generic manner, and may include surveys, questionnaires, comment cards, etc.
Behavioral data: Data representative of a series of actions performed by a user while visiting a website. Behavioral data include visited webpages, order of visited webpages, time spent on the visited webpages, specific interactions with the visited webpages, etc. The behavioral data are generally collected from the user device by an analytic server, which further processes the data collected from a plurality of user devices of visitors for the website.
Web server: A device that has, as one if its purposes, to respond to requests placed to the web server over the Internet by Internet-communicating devices using web protocols. A web server can include multiple virtual or physical machines providing responses to web protocol requests, such as webpage content to generate webpages of a website on a web client, RSS data, etc. Often such web servers are behind a dedicated device that balances the workload between the different physical servers.

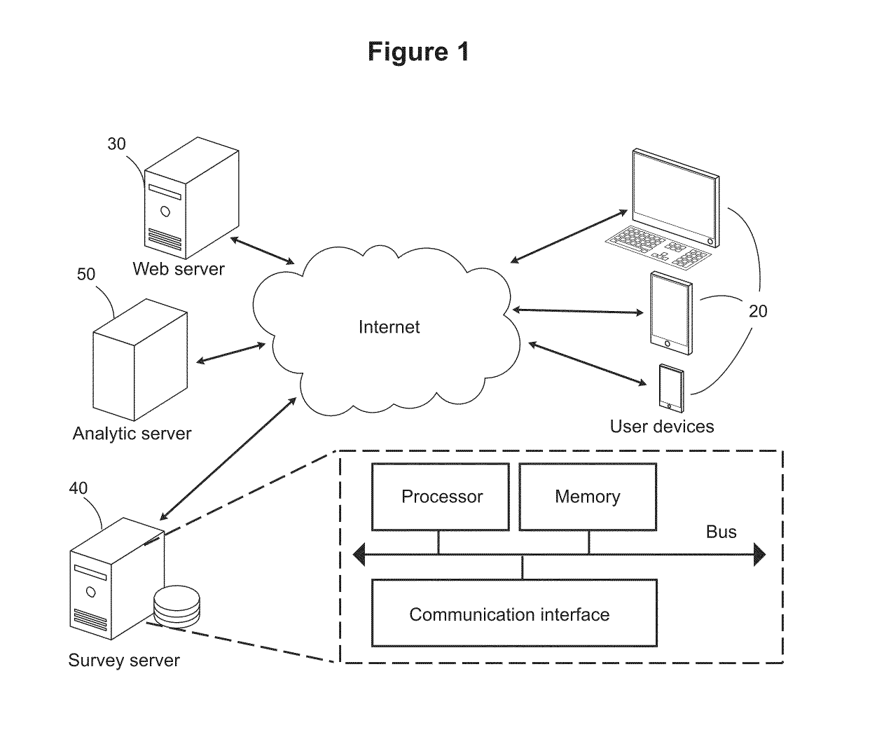

The present disclosure is made referring to FIG. 1, which represents a transaction-based environment (such as an electronic commerce environment) involving in combination processing system-based devices, such as a user device 20 hosting a web client (for instance a web browser), a web server 30 and a survey server 40. The different devices which participate in the process are in communication over a communication network, such as the Internet 10 or a plurality of networks linked or bridged electronically, optically or wirelessly and permitting communication between the different devices.

For the purpose of the present disclosure, a method and survey server for generating performance metrics of URLs of a website will be depicted in relation with the above-described environment. One must understand that this environment is for illustration purposes only. It is not intended to limit the scope of the present method and server. Furthermore, optional devices may also participate in the above-described environment. Examples of optional devices include a web analytic server 50 and a tag management server (not illustrated in the Figures).

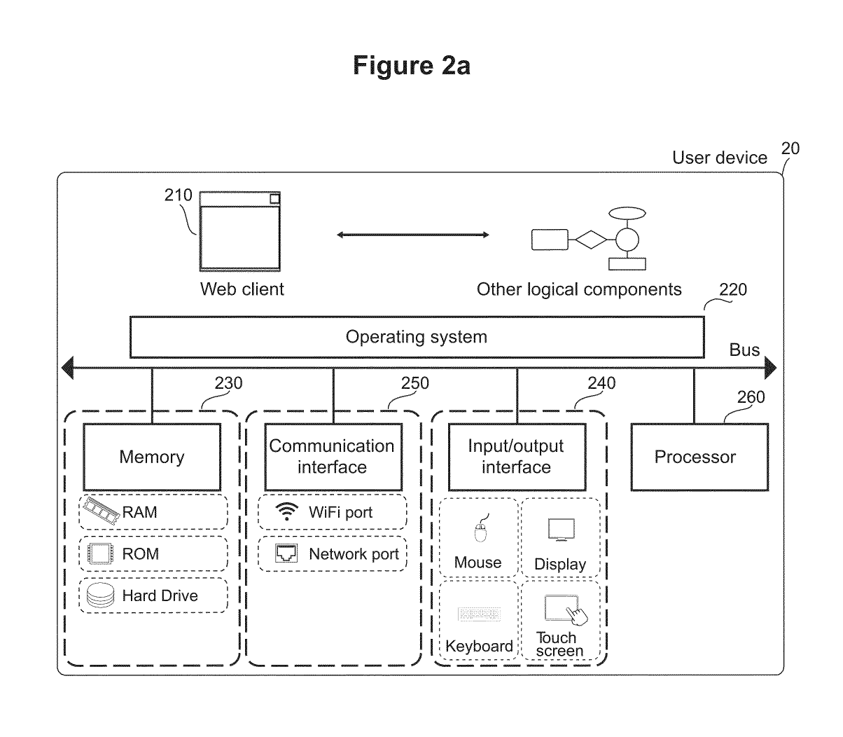

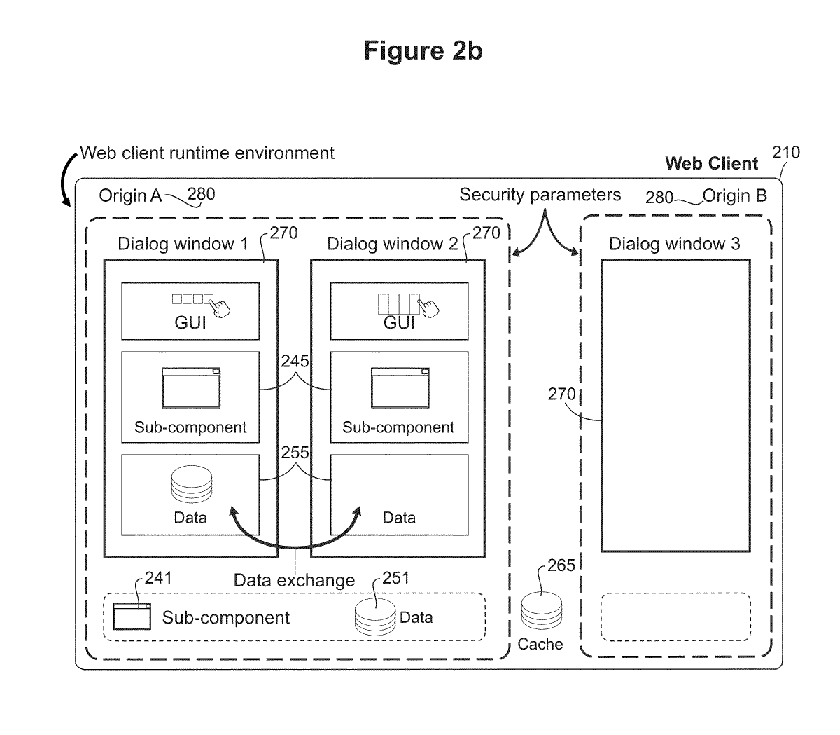

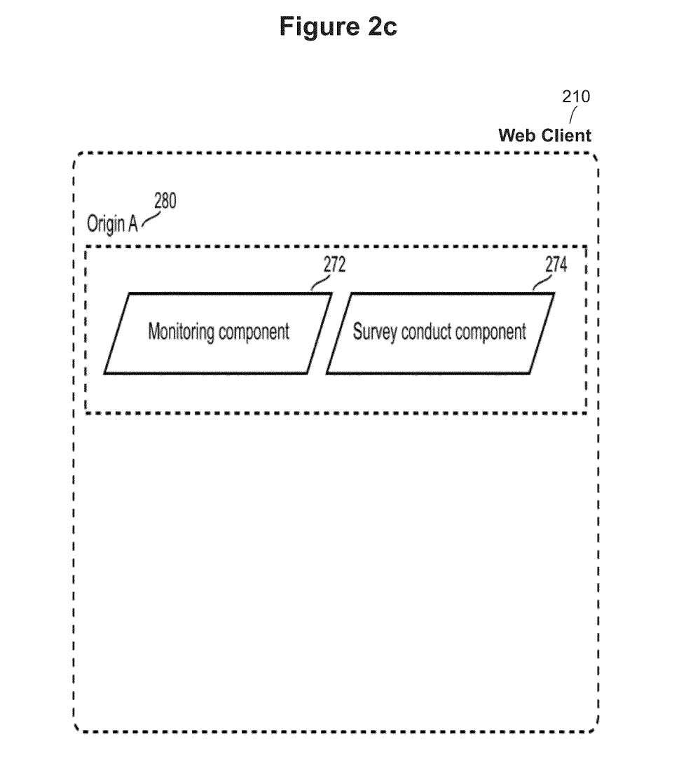

Reference is now made concurrently to FIGS. 1 and 2a. FIG. 2a illustrates an example of a generic-purpose user device 20 hosting a web client 210. The user device 20 comprises hardware components and software components. The software components are generated when a user device processing unit 260 processes codes or instructions stored on memory 230 associated therewith. The processing unit 260 may comprise one or several processors, each processor including one or several cores. As illustrated, the web client 210 is hosted by the user device 20. The web client 210 is a software component which may either be manufactured with the user device 20, or the web client 210 may be installed later. The web client 210 may consist in a web browser such as Microsoft Internet Explorer™, Google Chrome™, Apple Safari™, Mozilla Firefox™, etc. Other web client 210 customized for specific tasks and/or processes and designed to communicate with specific servers, may be available such as those developed under the Adobe Integrated Runtime (AIR) or Windows Runtime (Win RT) environment. The user device may also include other software components. The web client 210 and the other software components are supported by an operating system 220 providing the necessary runtime environment and bridging the software components with the hardware components when necessary. The user device 20 further comprises the following hardware components (as illustrated in FIG. 2a): an input/output interface 240 and a communication interface 250 for communicating over a network (e.g. the Internet). The web client 210 is designed to interact with the hardware components in a functional manner through the operating system 220, for instance to access memory 230 for reading and writing purposes, to communicate with remote processing system-based devices via the communication interface 250, to display information, and to receive input from the user via the input/output interface 240 (for instance trough keyboard and mouse controls).

Reference is now made concurrently to FIGS. 1, 2a and 2b. The web client 210 is designed to access a website, by exchanging data packets with a web server 30 hosting the website, and downloading and processing web content, such as HTML documents, provided by the web server 30.

The web client 210 is further adapted to provide the necessary runtime environment for software sub-components to be generated when the received webpage content includes embedded instructions (e.g. scripts). The resulting software sub-components run according to the runtime environment, parameters and security policies of the web client 210, as sub-components of the web client 210. In particular, the web client 210 is adapted to apply security policies in relation with the provided runtime environment. For instance, the security policies limit accessibility of information and processes according to origin identification, therefore isolating data relative to a dialog window with respect to one origin from another dialog window (and associated processes) with respect to another origin.

The web client 210 is further designed to store in memory 230, according to runtime environment policies, codes such as scripts and cookies. In relation with the graphical user interface provided by the web client 210, one or more dialog windows 270 may be present per origin identifier 280 during an ongoing web session. The security policies and runtime environment provided by the web client 210 permit to keep data in association with dialog windows 270 (e.g. data 255) or with origin identifier 280 (e.g. data 251). They also permit data exchanges between the data 251 and 255, or between data 255 corresponding to different dialog windows 270 (e.g. dialog window 1 and dialog window 2 in FIG. 2b).

The security policies and runtime environment provided by the web client 210 generate sub-components 241 and 245 associated with either the origin identifier 280 or the dialog windows 270. Such sub-components 241 and 245 include sub-components generated based on received web content (e.g. scripts).

The dialog windows 270 may either or not be part of the same browsing session, based on the web domain the dialog windows 270 are in communication with. As illustrated, the origin identifier 280 (e.g. origin A and origin B in FIG. 2b) establishes a security parameter for isolating information (e.g. 251 and 255), sub-components (e.g. 241 and 245), and resulting processes, from one browsing session with respect to another browsing session. The isolation is based on the origin identifier 280, rather than on a graphical presentation in the graphical interface of the web client 210.

The web client 210 further comprises a cache 265 that may be used to store web content. When a website visit request is performed, the web client 210 may retrieve from the cache 265 some or all of the web content collected during a previous web session, which has been stored in the cache 265 earlier. The object of the cache 265 is to accelerate webpage generation and display, by decreasing the needs of data exchange between the web client 210 and the web server 30.

The processing unit 260 executes instructions of the web client 210. During the execution of the instructions of the web client 210, the processing unit 260 accesses memory 230, uses the communication interface 250 to send and receive data packets, and relies on the input/output interface 240 to obtain inputs from the user and display webpages on a display of the user device 20, etc. Upon visiting of a website, the webpage content received from the web server 30, in order for the web client 210 to generate and display webpages, includes at least one of: 1) HTML documents, 2) Content Style Sheets (CSS) capable of providing display layouts and rules used to determine the layout for generating a webpage to be displayed, and 3) discrete webpage content to be integrated in the displayed webpage independently from a webpage structure provided by the HTML document and the Content Style Sheet. Examples of discrete webpage contents include text elements, images, sounds, videos, animations, etc.

Reference is now made to FIG. 2c, which illustrates a series of sub-components (a behavioral monitoring component 272 and a survey conduct component 274) that are generated by the web client 210, and run according to the runtime environment provided by the web client 210. The functions of the behavioral monitoring component 272 and the survey conduct component 274 will be detailed later in the description. Furthermore, as illustrated in FIGS. 2b and 2c, the behavioral monitoring component 272 and the survey conduct component 274 are limited to perform processes within a determined set of security parameters, based on the origin identifier 280 they are associated with.

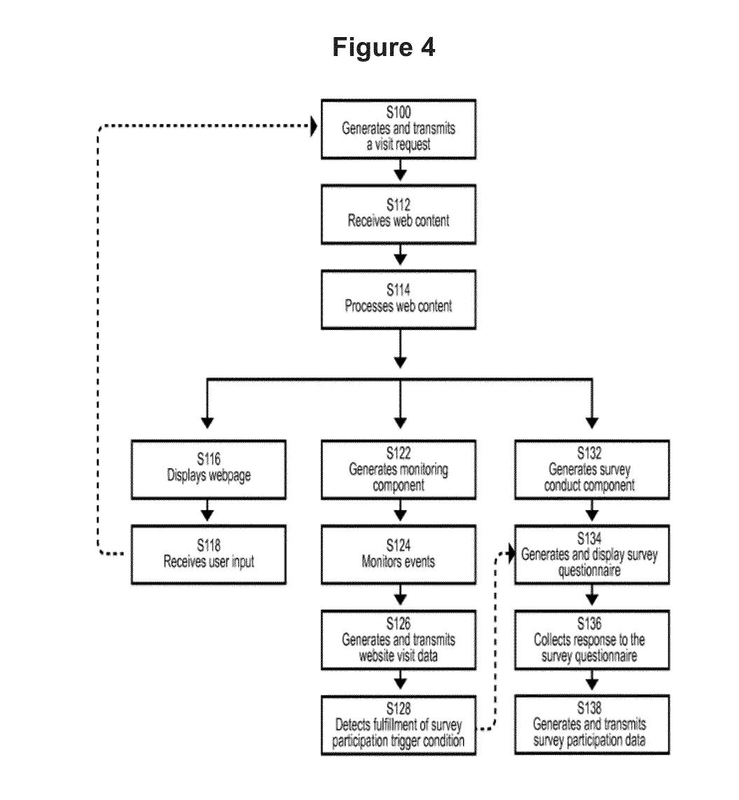

Reference is now made concurrently to FIGS. 1, 2a, 2b, 2c, 3a and 4, which illustrate steps performed by the user device 20 for collecting website visit data and survey participation data.

At step S100, the web client 210 of the user device 20 generates and transmits a website visit request, through the communication interface 250, to the web server 30. The website visit request is characterized by a Uniform Resource Locator (URL) corresponding to a webpage of the website hosted by the web server 30 (or a series of web servers 30). The web server 30 responds to website visit requests relative to the website(s) it is hosting.

At step S112, the web client 210 of the user device 20 receives from the web server 30 web content in response to the website visit request. The web content transmitted by the web server 30 includes an HTML document, and may contain content style sheet (CSS) and discrete web content.

At step S114, the user device 20 processes the web content (HTML document and optional additional data) transmitted by the web server 30. The processing is performed according to the runtime environment provided by the web client 210. Processing the web content includes generating a webpage to be displayed, and optionally processing instructions (e.g. scripts in a high-level language such as Java Script) embedded in the web content.

In an alternative, a tag manager server (not illustrated in the Figures) is used. In this case, processing of the instructions embedded in the web content triggers communication with the tag manager server, which further transmits additional instructions to the user device 20. The transmitted instructions are afterwards processed by the user device 20, as if they had been embedded in the web content transmitted by the web server 30. Accordingly, instead of integrating a plurality of scripts in the web content hosted by a website, the website's owner may use this alternative implementation to transmit the plurality of scripts using a single triggering script (to trigger the communication with the tag manager server) embedded in the web content.

In another alternative, part or all of the web content hosted by the web server 30 is directly retrieved from the cache 265. Once retrieved or received, the web content is processed regardless of the device (e.g. web server 30) or component (e.g. cache 265) transmitting it.

As a preamble to the description of steps S116, S122, and S132, one shall understand that these steps are illustrated as part of parallel processes that may be performed sequentially and/or concurrently, even if they collect information from each other or trigger one another. The sub-components performing these steps may be generated at different times during a web session.

At step S116, the web client 210 of the user device 20 generates and displays, on a display of the user device 20, the webpage resulting from the processing of the web content transmitted by the web server 30.

At step S118, the web client 210 of the user device 20 receives an input, via the input/output interface 240, from the user of the user device 20. The input may vary, and includes changing the viewable portion of the webpage, inputting information in a form to activate a control, initiating a new website visit request (followed by the execution of step S100 for the new website visit request), etc. These are usual steps during a visiting of a website, and they may occur within the limits of the ongoing browsing session according to the current origin identifier 280 of the currently visited website. Accordingly, many website visit requests may be generated and responded to within the limits of an ongoing browsing session, each website visit request being characterized by an URL corresponding to a webpage of the website.

At step S122, the behavioral monitoring component 272 (illustrated in FIG. 2c) is generated by the web client 210 of the user device 20. The behavioral monitoring component 272 is generated according to the processing of instructions embedded in web content received at step S112, and processed according to the runtime environment of the web client 210. The behavioral monitoring component 272 initiates a monitoring and transmission process. The behavioral monitoring process comprises monitoring the URLs of all the webpages displayed by the user device 20 at step S116, the URLs corresponding to website visit requests generated at step S100 during the ongoing browsing session.

At step S124, the behavioral monitoring component 272 of the user device 20 monitors the URLs corresponding to the website visit requests generated at step S100. In other words, the behavioral monitoring component 272 collects the URLs associated with the ongoing browsing session, according to the current origin identifier 280 of the currently visited website.

According to an alternative, the step S124 also comprises monitoring, by the behavioral monitoring component 272, actions performed by the user of the user device 20 in relation with the displayed webpages. The actions may include the time spent on a particular webpage, the mouse over actions, the scrolling up and down actions for modifying the portion of the webpage visible to the user, the filling of forms, the clicks on links and other webpage components, the activation of webpage-embedded content (such as wizards and other interactive content), the order of the webpages visited, etc.

At step S126, the behavioral monitoring component 272 of the user device 20 generates and transmits website visit data (the monitored URLs and optionally the monitored actions, generally referred to as behavioral data) to the survey server 40. According to alternatives, the website visit data may be transmitted whenever a new URL is monitored, or after the collection of data related to a plurality of URLs associated with the ongoing browsing session. The behavioral monitoring component 272 may keep the website visit data in memory 230, or store them in a file such as a cookie before transmitting them. The format of the website visit data may include URLs, or Uniform Resource Identifiers (URIs), or an origin identifier 280 and partial URLs. Accordingly, many format of website visit data may be used to transmit the information indicative of the monitored URLs. Furthermore, the format may vary, including a clear text form, an XML document, an encrypted file format, etc.

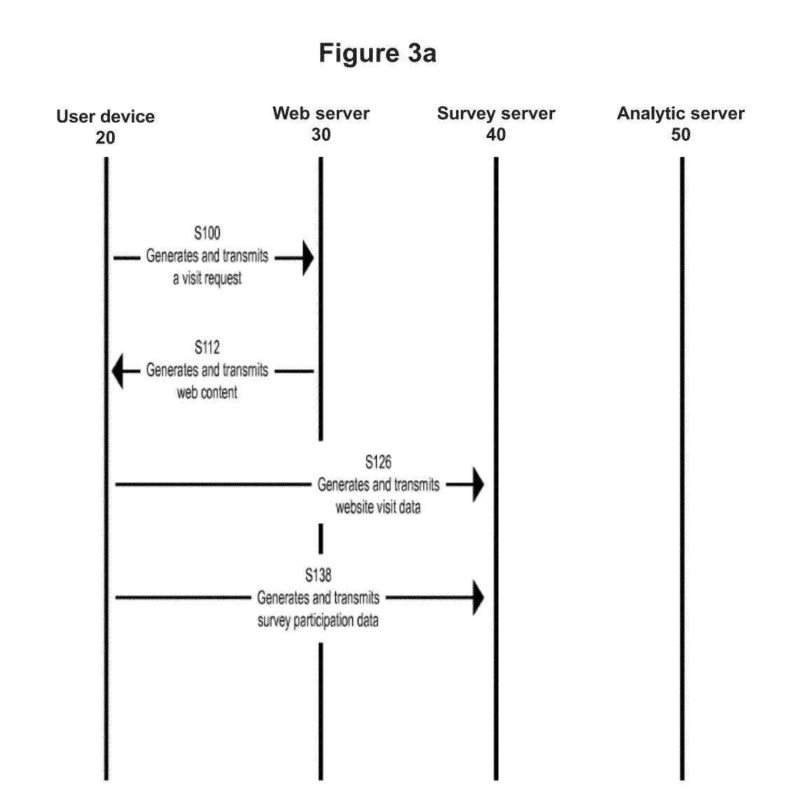

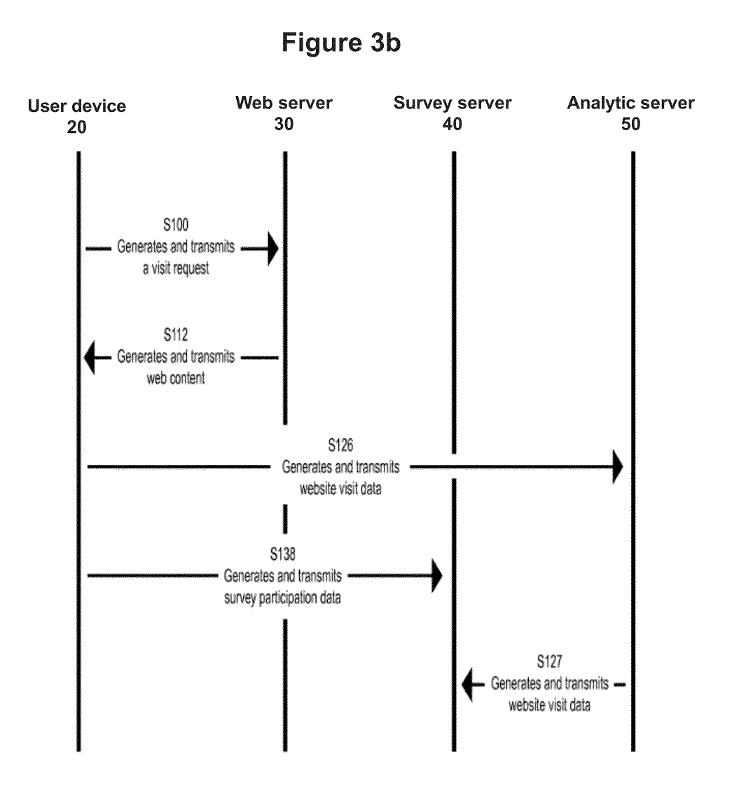

Alternatively, as illustrated in FIG. 3b, the behavioral monitoring component 272 of the user device 20 generates and transmits, at step S126, the website visit data to a web analytic server 50. Later, at step S127, the website visit data are retransmitted by the web analytic server 50 to the survey server 40. In another alternative (not represented in the Figures), the web server 30 may be the entity collecting and transmitting the website visit data to the survey server 40.

At step S128, the behavioral monitoring component 272 of the user device 20 detects that a survey participation trigger condition has been fulfilled. The trigger condition may take many forms, including the detection of a particular event during the current ongoing browsing session (such as clicking on a particular hyperlink), environmental factors (such as a time period between the occurrence of a specific event identified in the collected behavioral data and an initiation of the current ongoing browsing session), etc. Another example of survey participation trigger consists in the repetition of a same specific event, identified in the collected behavioral data and detected during the current ongoing browsing session. As illustrated by the above examples, the trigger conditions that can be defined for triggering the conduct of a survey are numerous. Furthermore, they are dependent on the objectives of the entity requesting and/or conducting the survey. In some embodiments, a combination of conditions may also be used to trigger the conduct of a survey.

At step S132, the survey conduct component 274 (illustrated in FIG. 2c) is generated by the web client 210 of the user device 20. The survey conduct component 274 is generated according to the processing of instructions embedded in web content received at step S112, and processed according to the runtime environment of the web client 210. The survey conduct component 274 initiates a survey conduct and transmission process.

The survey conduct component 274, upon generation, triggers the opening of a survey invitation. The survey invitation is displayed either in a dialog window 270 put in front of the other dialog windows 270 currently displayed on the display of the user device 20, or as a new overlay dialog window 270. The survey invitation may be displayed along with the first webpage of the website generated and displayed (at step S114 and S116), usually the home webpage. The survey invitation solicits a response from the visitor regarding a participation in the survey later during their visit of the website. Once the response is received, the dialog window 270 associated with the survey invitation is closed. If the visitor of the website accepts the invitation, the behavioral monitoring component 272 monitors the visit of the website and transmits the collected website visit data to the survey server 40. If the visitor of the website refuses the invitation, the behavioral monitoring component 272 does not monitor the behavior of the user of the device during the visit of the website. Furthermore, the survey conduct component 274 opens a survey conduct window once the behavioral monitoring component 272 detects that a condition associated to the survey invitation is fulfilled. For instance, when the condition is “at the end of the visit”, the survey conduct window is opened when the behavioral monitoring component 272 detects that the visitor has closed all dialog windows 270 associated with the visit of the website.

In a particular embodiment, the behavioral monitoring component 272 is generated and executed through the opening (e.g. via a script) of a blank window associated to the survey invitation window (when the visitor accepts the invitation to participate in the survey). The blank window hosts the behavioral monitoring component 272 with the same origin identifier 280 as the visited website; and allows the behavioral monitoring component 272 to communicate with the survey server 40 without overcoming the security policies applied by the web client 210.

At step S134, the survey conduct component 274 of the user device 20 generates a survey questionnaire, either based on embedded data (web content received at step S112) or based on further communication with the survey server 40. The survey questionnaire is then displayed on the display of the user device 20.

The survey questionnaire comprises at least one question displayed in an additional dialog window 270, positioned in front of the other dialog windows 270 displayed by the web client 210. At least one of the questions of the survey questionnaire consists in asking the user of the device (i.e. the participant to the survey) if, during the ongoing browsing session and visit of the website, the purpose of the visit was fulfilled. The survey questionnaire may comprise additional questions, such as the original purpose for visiting the website (e.g. information, purchase, support, etc.). The survey questionnaire may also comprise open-ended questions, for the user (also referred to as the survey participant) to provide comments. The questionnaire survey may further include questions not related to the visit, such as demographic questions (e.g. age, gender, etc.).

The presentation of the survey questionnaire varies, based on a particular type of web survey to be performed. For instance, the survey questions may be provided in a sequence of windows, wherein only one or a few questions are provided at a time. When all survey questions contained in a current window are answered, the current window is replaced with a new one (or refreshed) with new question(s). Alternatively, the survey questions are assembled in a single user interface (e.g. a single window) and provided all together.

The format of the responses to the survey questions may vary, including ratings, ordering of elements, selection of an element among a series of available elements, graphical controls to provide responses (e.g. a sliding control on a graduate ruler), open-ended questions wherein the survey participant provides a response in his own words in a free-text format, a combination thereof, etc.

At step S136, the survey conduct component 274 receives responses to the survey question(s) from the survey participant. The number of responses may be limited to one, or may include a series of responses to a series of questions provided according to one or more of the above-discussed formats.

At step S138, the survey conduct component 274 transmits survey participation data, indicative of the responses to the survey questionnaire received at step S136, to the survey server 40. The survey participation data include at least an indication of whether the survey participant deems that the purpose of visit of the website has been fulfilled during the browsing session.

In an alternative embodiment, instructions embedded in an initial web-content (received at step S112) may be used to generate (at step S114) a communication portal component on the user device 20, for controlling further communications between the user device 20 and the survey server 40 (e.g. transmission from the survey server 40 to the user device 20 of parameters, data, additional scripts, etc.). Accordingly, already running processes and sub-components of the web client 210 may take into account newly transmitted data from the survey server 40 (e.g. a script, a survey questionnaire, etc.) and new sub-components may be generated based on the transmitted data, according to the runtime environment of the web client 210.

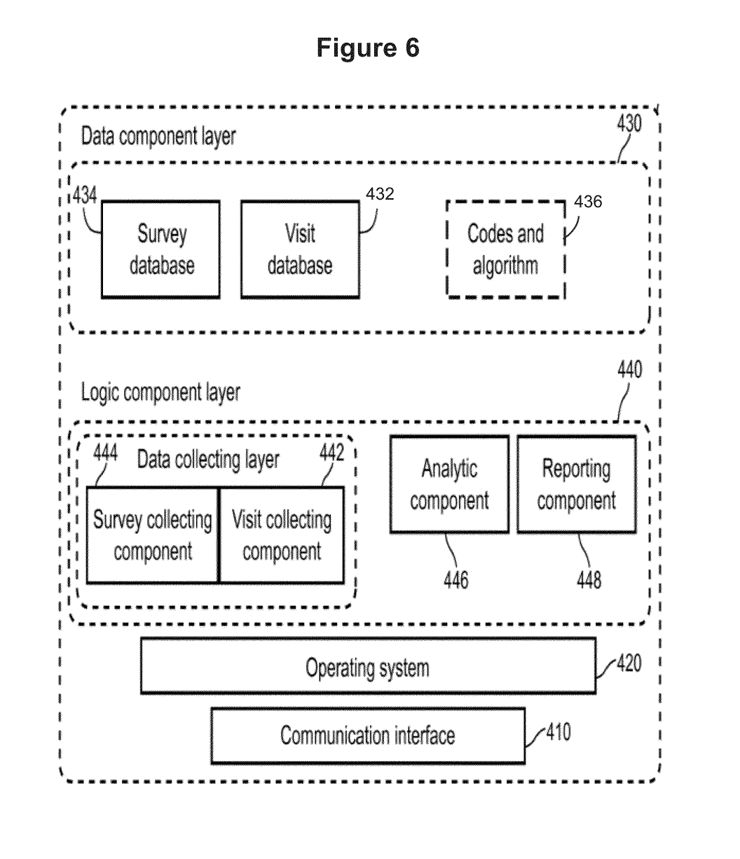

Reference is now made concurrently to FIGS. 1 and 6. FIG. 6 represents the survey server 40. The survey server 40 comprises a communication interface 410 for communicating over a network (e.g. the Internet), memory (not represented in FIG. 6 for simplification purposes), and a processing unit (not represented in FIG. 6 for simplification purposes). The processing unit may comprise one or several processors, each processor including one or several cores. The memory stores software instructions corresponding to a data component layer 430 (dedicated to data storage) and a logic component layer 440 (dedicated to data processing). An operating system 420 provides the necessary runtime environment, and bridges software components of the survey server 40 with its hardware components when necessary.

The data component layer 430 is used to store survey participation data (e.g. in a survey database 434) and website visit data (e.g. in a visit database 432) received via the communication interface 410 from one or several user devices 20. The data component layer 430 comprises codes and algorithms 436 used to generate and provide parameters to the logic component layer 440, based on the processing of the data of the survey database 434 and visit database 432.

The logic component layer 440 comprises the following components: a) a visit collecting component 442 used to collect the website visit data (via the communication interface 410) and to store the collected website visit data in the visit database 432, and b) a survey collecting component 444 used to collect the survey participation data (via the communication interface 410) and to store the collected survey participation data in the survey database 434.

The logic component layer 440 further comprises an analytic component 446 for analyzing the collected website visit data and survey participation data to generate performance metrics of the URLs of a particular website; and a reporting component 448 for generating reports based on the output provided by the analytic component 446.

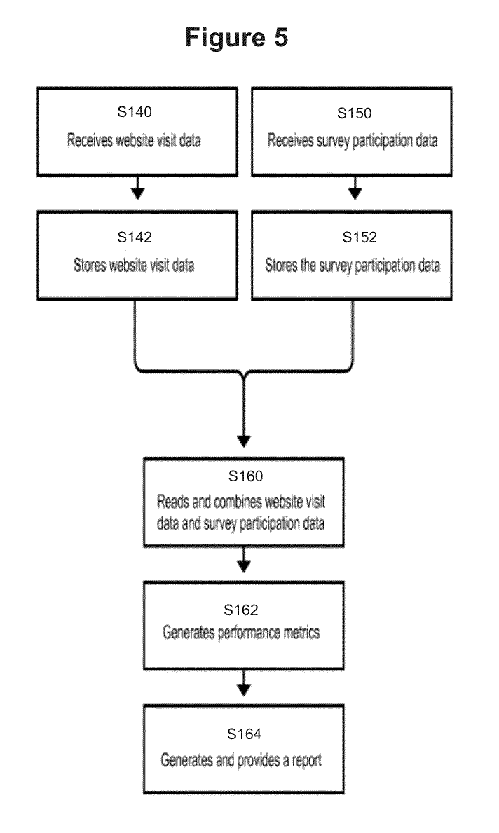

Referring now concurrently to FIGS. 5 and 6, the method performed by the survey server 40 for generating performance metrics of the URLs of the website is illustrated. The following steps are implemented by the processing unit of the survey server 40.

At step S140, the visit collecting component 442 receives website visit data via the communication interface 410. The website visit data are generally received from the user device 20 (step S126 in FIG. 3a). As mentioned previously, the website visit data may be collected and transmitted by another source, such a web analytic server 50 (steps S126 and S127 in FIG. 3b) or the web server 30. The website visit data (generally referred to as behavioral data) comprise URLs (indicative of the visit of the website by the user device 20), and optionally monitored actions.

At step S142, the received website visit data are stored in the visit database 432 by the visit collecting component 442.

At step S150, the survey collecting component 444 receives survey participation data via the communication interface 410. The survey participation data are received from the user device 20 (step S138 in FIG. 3a). The received survey participation data comprise an indication of whether the survey participant deems that its purpose of visit has been fulfilled during the browsing session.

In a particular embodiment, a series of data exchange takes place between the user device 20 and the survey server 40, before the survey server 40 starts receiving the survey participation data, for setting parameters according to which the survey is conducted on the user device 20.

At step S152, the received website visit data are stored in the survey database 434 by the survey collecting component 444.

At step S160, the analytic component 446 reads and combines website visit data (from the visit database 432) and survey participation data (from the survey database 434). This step is performed when the survey server 40 has received survey participation data and website visit data regarding a sufficient number of visits of the website, to be capable of establishing relevant correlations between the two types of data at step S162. The combination may include determining website visit data and survey participation data corresponding to a common user device 20. As is well known in the art, a unique identifier of the common user device 20 or a unique identifier of the user of the common user device 20 (transmitted with the website visit data and survey participation data) can be used for performing the determination of the corresponding website visit data and survey participation data.

At step S162, the analytic component 446 analyzes the website visit data (specifically the URLs of the visited webpages) in view of the survey participation data (specifically the indications of whether the participants to the survey deem that their purpose of visit has been fulfilled during the browsing session) to generates performance metrics of the URLs with respect to fulfilling the purpose of visit of the participants. Performance metrics may take various forms well known in the art, such as for example a percentage of satisfaction for each specific URL of the website (a percentage of the visitors having visited the webpage corresponding the specific URL and responded to the survey with an indication that their purpose of visit has been fulfilled during their browsing session).

According to an alternative, the analytic component 446 also takes into account the sequence of the visited URLs (representative of the sequence of display of the corresponding webpages of the website on the display of the user device 20, and generally referred to as the visit path of the user). In this case, the URLs of the visited webpages provide information on a “level of distress” of the visitor during his visiting of the website, and the specific sequence of the URLs also provides information on a “level of chaos” of the visitor during his visit path through the webpages of the website. According to that alternative, the analytic component 446 establishes a chaotic metric (based on the analysis of the sequence of the URLs of the visited webpages with respect to fulfilling the purpose of visit of the participants), and this chaotic metric is either used alone or in combination with other data, for generating analytic results.

According to another alternative, actions performed on the visited webpages by the user of the user device 20 are received and analyzed in combination with the URLs of the visited webpages. According to this alternative, additional insight on the “level of distress” experienced by a visitor while visiting a particular webpage (for which action(s) have been collected) may be provided.

According to still another alternative, the analysis performed by the analytic component 446 on the collected URLs relies on entropy-based measures, in conformance with the information theory of entropy measurements, which is well known in the art. According to this alternative, measures and metrics of frequency and of level of distress are obtained through this analysis. Webpages visited and displayed more than once during the same browsing session of a visitor (frequency of display of the webpages on the display of the user device 20) are reflected in the collected website visit data (by including a frequency of the corresponding URLs), and thus taken into consideration for the analysis.

At step S164, the reporting component 448 generates and provides a report on the performance of the URLs of the website (with respect to fulfilling the purpose of visit of the visitors), based on the performance metrics generated by the analytic component 446.

For instance, the generated report may be provided to a representative of the website in the form of a print out, a static report displayable via electronics means, an interactive report displayable via electronics means, etc. In the case of an interactive report, if the survey questionnaire includes additional questions such as a request to identify the purpose of visit of the visitors of the website, the interactive report may permit to generate reports on demand, based on filters related to the identified purposes of visit. The generated report may provide additional information, such as statistics on whether or not various purposes of visit have been fulfilled, the number of users who fulfilled their purpose of visit, etc. Accordingly, the representative of the website may determine, when reading the report, the performance of the webpages of the website with respect to one of the following purposes of visit: the visitors who planned to buy from the website, the visitors who bought something in the past and who are looking for additional information (e.g. support, self-access content such as drivers and user manuals), etc.

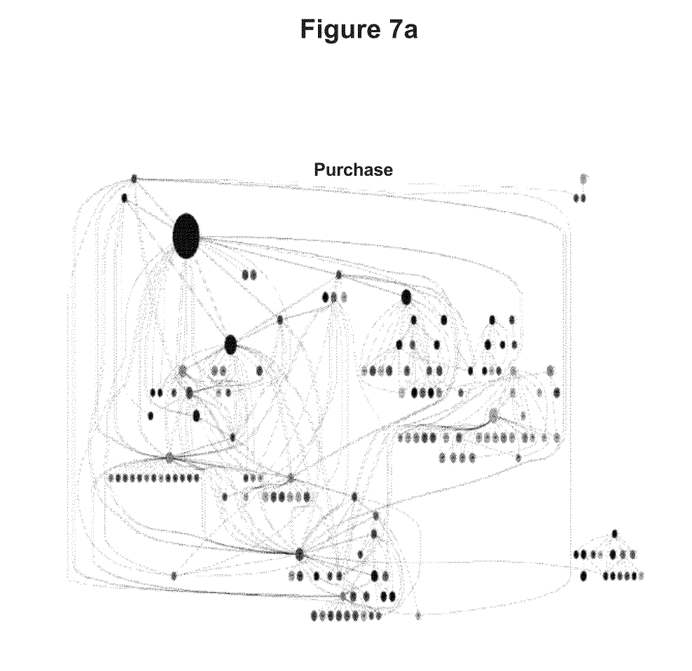

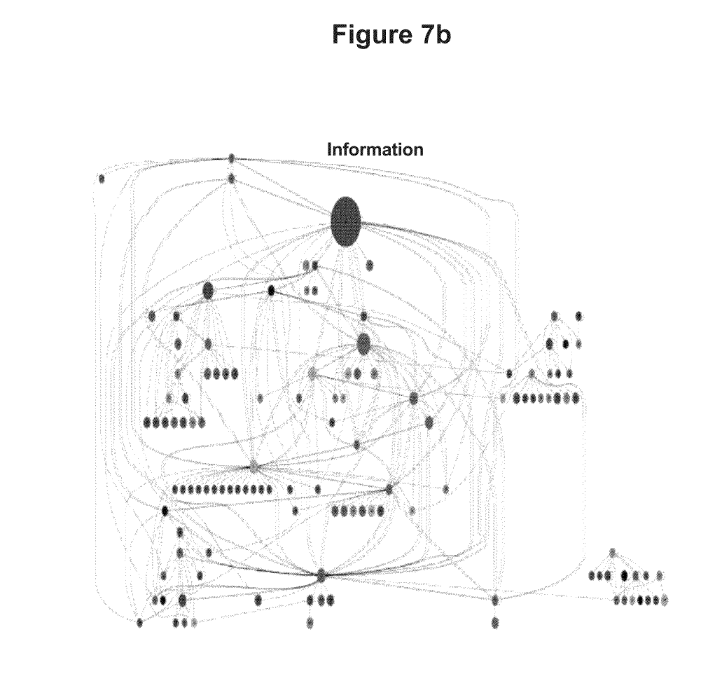

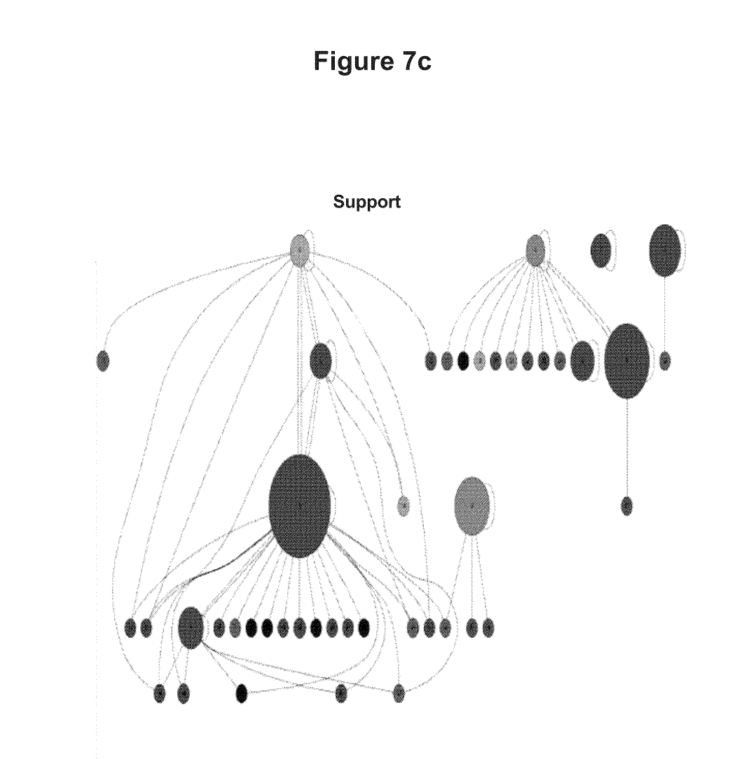

Referring now concurrently to FIGS. 7a, 7b, and 7c, examples of reports are represented. FIG. 7a represents an exemplary report of website distress mapping in relation with a “purchase” purpose of visit. FIG. 7b represents an exemplary report of website distress mapping in relation with an “information” purpose of visit. FIG. 7c represents an exemplary report of website distress mapping in relation with a “support” (e.g. customer service) purpose of visit.

In these exemplary reports, each node represents a specific webpage of the website. The size of the node is indicative of the frequency at which the corresponding webpage is visited in relation with the purpose of visit (purchase, information or support) that is the object of the report.

The distress level attributable to a particular webpage is represented via a color of the corresponding node. For instance, a node having a deep-red color is indicative of a webpage having a very high distress level associated therewith, the distress level decreasing along the deepness of the red color applied. At the other end of the spectrum, nodes having blue and green colors are indicative of webpages having a low distress level associated therewith. Lines between the nodes represent visit paths (the sequence of the URLs) used by visitors of the website, when browsing through the webpages.

Additional algorithms for data collection and/or analysis may be implemented on the user device 20 and survey server 40 respectively. For instance, weights may be allocated to the webpages (represented by their URLs) of the visited website. Each weight can be based on one of the following: rank of the corresponding webpage in the sequence of visit of the website, display frequency of the corresponding webpage, proportion of the corresponding webpage displayed on the display of the user device 20, time spent on the corresponding webpage, etc. Specific reports may be implemented to illustrate the potential impact of one or more of the aforementioned types of weights on the webpage performance metrics.

The reports may have different formats, including bar charts, pie charts, clustering representations, path based representations, etc. The particular format of a report is determined based on the most efficient or practical way of representing the corresponding webpage performance metrics with respect to the purpose(s) of visit of the visitors of the website. For instance, the format of the reports for a website dedicated to e-commerce may differ from the format of the reports for a website dedicated to information and education.

In the exemplary reports represented in FIGS. 7a, 7b and 7c, the analysis is performed on the website visit data (the URLs) according to a specific purpose of visit: purchase in FIG. 7a, information in FIG. 7b, and support in FIG. 7c. These exemplary categories of purpose of visit represent business categories for which the owner of the website provides services to its customers via the website. These categories are provided for illustration purposes only, and are not intended to limit the scope of the potential purposes of visit.

Different languages and formats may be used to transmit the survey participation data from the user device 20 to the survey server 40, using a more or less structured data format. For instance, the survey participation data may be transmitted using a text file format, an XML format, a structured file format with table structures embedded in the file containing the survey participation data. The survey participation data may be encrypted by the user device 20 and decrypted by the survey server 40. The encryption technology used is one among known encryption technologies applicable to Internet data transmission.

The same format may be used for transmitting a customized survey questionnaire from the survey server 40 to the user device 20, and for transmitting the corresponding survey participation data (collected by the user device 20) from the user device 20 to the survey server 40. For instance, Triple-S XML, Quantum or Snap can be used.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for generating performance metrics of URLs of a website, comprising:
collecting at a survey server website visit data from a plurality of user devices, the website visit data comprising for each specific user device Uniform Resource Locators (URLs) of webpages of the website displayed on a display of the specific user device during a visiting of the website by a user of the specific user device;
collecting at the survey server survey participation data from some of the plurality of user devices, the survey participation data corresponding to survey information received from the users of the user devices in relation to the visit of the website, the survey participation data comprising an indication of the users having either or not fulfilled a purpose of visit during the visit of the website; and
analyzing by the survey server the website visit data and the survey participation data to generate performance metrics of the URLs of the website with respect to fulfilling the purpose of visit of the website.

2. The method of claim 1, wherein analyzing the website visit data and the survey participation data comprises determining website visit data and survey participation data corresponding to the same specific user device.

3. The method of claim 1, further comprising generating a report indicative of the performance of the URLs of the website with respect to fulfilling the purpose of visit of the website based on the generated performance metrics.

4. The method of claim 1, wherein the website visit data further comprise a sequence of the URLs collected during a visiting of the website by the user of the specific user device, the sequence of the URLs being representative of a sequence of display of the corresponding webpages of the website on the display of the specific user device, and the analyzing of the website visit data and the survey participation data to generate the performance metrics of the URLs takes into consideration the sequence of the URLs.

5. The method of claim 4, wherein taking into consideration the sequence of the URLs consists in allocating a particular weight to each URL based on its position in the sequence of URLs.

6. The method of claim 1, wherein the website visit data further comprise a frequency of the URLs collected during a visiting of the website by the user of the specific user device, the frequency of the URLs being representative of a frequency of display of the corresponding webpages of the website on the display of the specific user device, and the analyzing of the website visit data and the survey participation data to generate the performance metrics of the URLs takes into consideration the frequency of the URLs.

7. The method of claim 6, wherein taking into consideration the frequency of the URLs consists in allocating a particular weight to each URL based on its frequency.

8. The method of claim 1, wherein the website visit data further comprise a series of actions performed by the user of the specific user device while visiting the website, and the analyzing of the website visit data and the survey participation data to generate the performance metrics of the URLs takes into consideration the series of actions.

9. The method of claim 8, wherein the actions consist in one of the following: a time spent on a particular webpage, a mouse over action, a scrolling up or down action for modifying the portion of a webpage visible to the user, a filling of a form, a click on a link, and an activation of a webpage-embedded content.

10. The method of claim 1, wherein the survey participation data further comprise an identification of the purpose of visit of the website.

11. The method of claim 10, wherein the analyzing of the website visit data and the survey participation data to generate the performance metrics of the URLs is performed with respect to a particular purpose of visit.

12. The method of claim 11, wherein the particular purpose of visit comprises one of the following: information, purchase, and support.

13. A computer program product comprising a readable memory storing computer executable instructions thereon, the instructions when executed by a processing unit of a survey server provide for generating performance metrics of URLs of a website by:
collecting at the survey server website visit data from a plurality of user devices, the website visit data comprising for each specific user device Uniform Resource Locators (URLs) of webpages of the website displayed on a display of the specific user device during a visiting of the website by a user of the specific user device;
collecting at the survey server survey participation data from some of the plurality of user devices, the survey participation data corresponding to survey information received from the users of the user devices in relation to the visit of the website, the survey participation data comprising an indication of the users having either or not fulfilled a purpose of visit during the visit of the website; and
analyzing by the survey server the website visit data and the survey participation data to generate performance metrics of the URLs of the website with respect to fulfilling the purpose of visit of the website.

14. A survey server comprising:
a processing unit;
a communications interface for exchanging data with a plurality of user devices; and
memory for storing:
web site visit data and survey participation data;
code responsible, when performed by the processing unit, for:
collecting the website visit data from the plurality of user devices, the website visit data comprising for each specific user device Uniform Resource Locators (URLs) of webpages of the website displayed on a display of the specific user device during a visiting of the website by a user of the specific user device;
collecting the survey participation data from some of the plurality of user devices, the survey participation data corresponding to survey information received from the users of the user devices in relation to the visit of the website, the survey participation data comprising an indication of the users having either or not fulfilled a purpose of visit during the visit of the website; and
analyzing the website visit data and the survey participation data to generate performance metrics of the URLs of the website with respect to fulfilling the purpose of visit of the website.

15. The survey server of claim 14, wherein analyzing the website visit data and the survey participation data comprises determining website visit data and survey participation data corresponding to the same specific user device.

16. The survey server of claim 14, wherein the code is further responsible for generating a report indicative of the performance of the URLs of the website with respect to fulfilling the purpose of visit of the website based on the generated performance metrics.

17. The survey server of claim 14, wherein the website visit data further comprise a sequence of the URLs collected during a visiting of the website by the user of the specific user device, the sequence of the URLs being representative of a sequence of display of the corresponding webpages of the website on the display of the specific user device, and the analyzing of the website visit data and the survey participation data to generate the performance metrics of the URLs takes into consideration the sequence of the URLs by allocating a particular weight to each URL based on its position in the sequence of URLs.

18. The survey server of claim 14, wherein the website visit data further comprise a frequency of the URLs collected during a visiting of the website by the user of the specific user device, the frequency of the URLs being representative of a frequency of display of the corresponding webpages of the website on the display of the specific user device, and the analyzing of the website visit data and the survey participation data to generate the performance metrics of the URLs takes into consideration the frequency of the URLs by allocating a particular weight to each URL based on its frequency.

19. The survey server of claim 14, wherein the website visit data further comprise a series of actions performed by the user of the specific user device while visiting the website, and the analyzing of the website visit data and the survey participation data to generate the performance metrics of the URLs takes into consideration the series of actions, the actions consisting in one of the following: a time spent on a particular webpage, a mouse over action, a scrolling up or down action for modifying the portion of a webpage visible to the user, a filling of a form, a click on a link, and an activation of a webpage-embedded content.

20. The survey server of claim 14, wherein the survey participation data further comprise an identification of the purpose of visit of the website, and the analyzing of the website visit data and the survey participation data to generate the performance metrics of the URLs is performed with respect to a particular purpose of visit, the particular purpose of visit comprising one of the following: information, purchase, and support.
